(19) United States
(12) Patent Application Publication
(10) Pub. No.: US 2008/0219798 A1
(43) Pub. Date: Sep. 11, 2008

(54) STEM PLUG MODIFICATIONS IMPROVING WIREDRAW FUNCTIONALITY

(75) Inventors: Rahmatollah Fakhri Toosky, San Clemente, CA (US); Scott P. Cohen, Corona, CA (US); Jerry D. Smith, Riverside, CA (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: SPS TECHNOLOGIES, LLC, Jenkintown, PA (US)

(21) Appl. No.: 11/684,162

(22) Filed: Mar. 9, 2007

(51) Int. Cl. F16B 13/04

(52) U.S. Cl. 411/43

(57) ABSTRACT

A blind rivet which includes a stem, a sleeve and a locking collar. The stem includes a head or plug portion, and the plug portion includes one or more grooves or depressions which provide that lower installation forces can be used to install the blind rivet, and if a sealant or paint is used, provide a type of escape mechanism for the sealant or paint to travel to during installation of the blind rivet. The grooves or depressions may vary in number and take on any number of shapes and sizes. For example, they may be longitudinal and may get wider and/or deeper toward the end of the stem.

### BACKGROUND

The present invention generally relates to stem plugs for installing blind rivets and more specifically relates to a stem plug which includes grooves or depressions.

Blind rivets are popular fasteners, for example, in the aircraft industry. A conventional blind rivet is shown in FIG. 1 and includes a stem 12, a locking collar 14 and a sleeve 16. The stem 12 has a generally cylindrical head 18 at one end 20 and a serrated portion 22 proximate an opposite end 24. As shown, the stem 12 extends through the sleeve 16 such that the head 18 of the stem 12 contacts the end 26 of the sleeve 16. The stem 12 also includes an enlarged portion such as a knurl 27 for retaining the sleeve 16 and collar 14. Actual installation of such a blind rivet requires the sleeve 16 of the blind rivet 10 to be inserted into an aperture in a workpiece, consisting of two or more structures, with a riveter used to grip and pull the serrated portion 22 of the stem 12 of the blind rivet 10.

Of primary concern in designing any new blind fastener is the selection of a grip adjustment mechanism enabling the fastener to install properly within a specified grip range. “Grip Range” is defined as the variation of the thickness of the workpiece in which the blind fastener is installed (typically 0.062 inches). In a wiredraw-type fastener, the grip compensation is accomplished by elongating, or drawing, the plug portion 18 of the stem 12 through the sleeve.

To ensure proper installation, a differential strength is required between the head of the stem and the serrated area 22. Moreover, the head must be soft enough to be able to extrude while being able to withstand the frictional and deformation forces associated with a wiredraw installation. An accepted practice in industry for providing the necessary hardness variation is by excessively cold working the serrated areas and annealing the plug portion of the stem. Another acceptable practice is to introduce a hole inside of the plug to effectively reduce the wiredraw loads.

Frictional and deformation loads are significant and the most prevalent inhibiting factors to allow smooth extrusion of the stem through the sleeve. Adding foreign substances, for example, primer paints or sealants, another hindrance is introduced. Frictional forces can increase substantially dependent upon the viscosity and texture of the fluid. As well, if any fluid becomes entrapped inside of the assembly during installation, the phenomenon of hydraulic locking could cause erratic fastener behavior. The sensitivity of the installation process prohibits any negative outside influence if the product is to work acceptably.

### OBJECTS AND SUMMARY

An object of an embodiment of the present invention is to provide an improved stem head or plug design which functions to provide decreased wire draw loads.

Another object of an embodiment of the present invention is to provide a stem head or plug design which provides a type of escape mechanism for sealants or paint during installation of a blind rivet.

Briefly, and in accordance with at least one of the foregoing objects, an embodiment of the present invention provides a blind rivet which includes a stein, a sleeve and a locking collar. The stem includes a head or plug portion, and the plug portion includes one or more grooves or depressions, and if a sealant or paint is used, provides a type of escape mechanism for the sealant or paint to travel during installation of the blind rivet. The grooves or depressions may vary in number and may take on any number of shapes and sizes. For example, they may be longitudinal and may get wider and/or deeper toward the end of the stern.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 illustrates a conventional blind rivet;

FIG. 2 illustrates a blind rivet which has a plug portion which is in accordance with an embodiment of the present invention, where a sleeve of the blind rivet is inserted in an aperture in a workpiece, but the blind rivet has not yet been installed;

FIG. 3 illustrates the blind rivet of FIG. 2, showing the blind rivet after it has been installed;

FIG. 4 provides a perspective view of the head or plug portion of the stem of the blind rivet shown in FIGS. 1-3;

FIG. 5 provides a top plan view of the plug portion of the stem;

FIG. 6 is a cross-sectional view of the plug portion, taken along line 6-6 of FIG. 5;

FIG. 7 is a cross-sectional view of the plug portion, taken along line 7-7 of FIG. 5;

FIG. 8 is a cross-sectional view of the plug portion, taken along line 8-8 of FIG. 5;

FIG. 9 provides a perspective view of a plug design which is in accordance with an alternative embodiment of the present invention; and

FIG. 10 provides a top plan view of the plug design shown in FIG. 9.

### DESCRIPTION

While the present invention may be susceptible to embodiment in different forms, there are shown in the drawings, and herein will be described in detail, embodiments thereof with the understanding that the present description is to be considered an exemplification of the principles of the invention and is not intended to limit the invention to that as illustrated and described herein.

An embodiment of the present invention provides a blind rivet which includes a head or plug portion which is designed to provide that lower installation forces can be used to install the blind rivet. Grooves or depressions are provided on the plug or head portion of the stem, and this significantly reduces the load required to wiredraw. By providing grooves or depressions, the cross-sectional area of the plug changes, and this has a significant effect on the loading pattern of the stem. Additionally, if a sealant or paint is used, the grooves or depressions provide a type of escape mechanism for the sealant or paint to travel to during installation of the blind rivet.

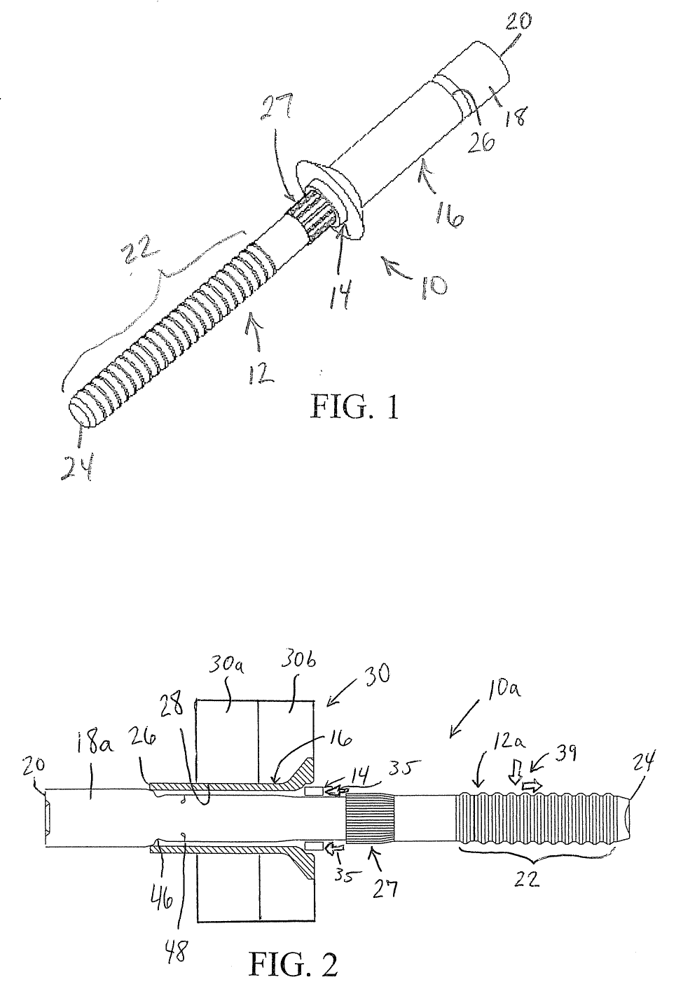

As shown in FIGS. 2 and 3, a blind rivet 10a in accordance with an embodiment of the present invention, much like a conventional blind rivet as shown in FIG. 1, includes a stem 12a, a locking collar 14 and a sleeve 16. The stem 12a has a head 18a at one end 20 and a serrated portion 22 proximate an opposite end 24. As shown, the stem 12a extends through the sleeve 16 such that the head 18a of the stem 12a contacts an end 26 of the sleeve 16. The stem 12a also includes an enlarged portion such as a knurl 27 for retaining the locking collar 14 and sleeve 16 on the stem 12a. While all this is conventional, the blind rivet 10a in accordance with an embodiment of the present invention provides a plug or head portion 18a having a novel design.

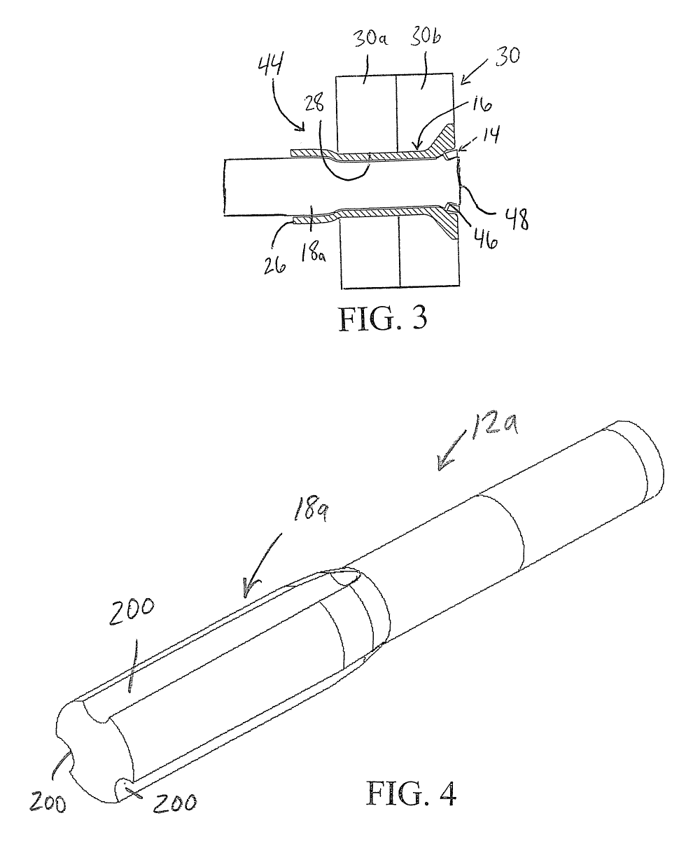

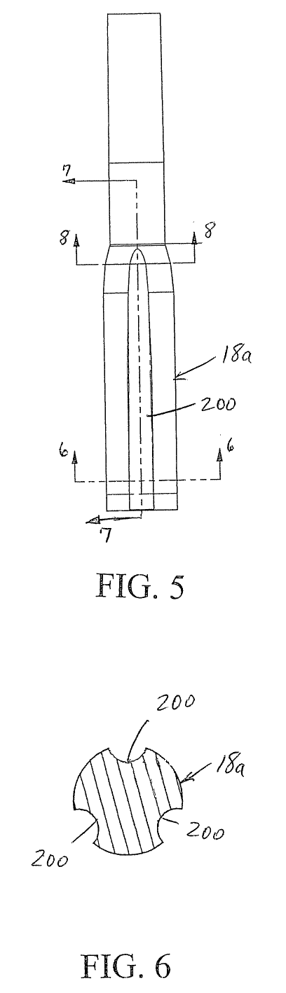

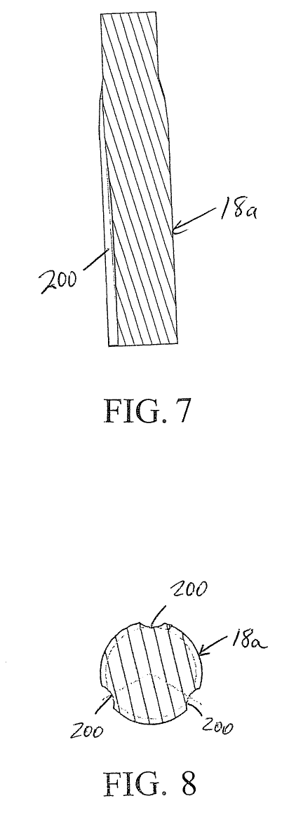

FIGS. 4 and 5 illustrate the plug or head portion 18a of the stern 12a in more detail. As shown, the plug 18a includes a plurality of spaced-apart grooves or depressions 200. The grooves or depressions 200 provide that lower installation forces can be used to install the blind rivet 10a, and if a sealant or paint is used, the grooves or depressions 200 provide a type of escape mechanism for the sealant or paint to travel to during installation of the blind rivet 10a. The grooves or depressions may vary in number and may take on any number of shapes and sizes. For example, they may be longitudinal and may get wider and/or deeper toward the end of the stem. FIGS. 4 and 5 illustrate an embodiment where the grooves or depressions 200 get deeper toward the end 20 of the stem 12a. This can readily be seen by comparing the cross-sectional view shown in FIG. 6 (taken along line 6-6 of FIG. 5) to the cross-sectional view shown in FIG. 8 (taken along line 8-8 of FIG. 5), and by considering the cross-sectional view shown in FIG. 7 (taken along line 7-7 of FIG. 5).

As shown in FIGS. 2 and 3, to install the blind rivet 10a, the sleeve 16 of the blind rivet 10a is inserted into an aperture 28 in a workpiece 30 (which consists of two or more structures 30a, 30b), and the jaws of a riveter (not specifically shown) are used to grip and pull (said gripping and pulling being represented with arrows 39 in FIG. 2) the serrated portion 22 of the stem 12a of the blind rivet 10a. This causes the sleeve 16 to upset in the blind area 44 of the workpiece 30, as shown in FIG. 3, thereby providing a clamp up load to the workpiece structures 30a, 30b. While the jaws of the riveter pull on the stem 12a, an installation load from the riveter to the fastener 10 is transferred through the locking collar 14 of the blind rivet 10 (said installation load being represented with arrows 35 in FIG. 2). This installation load is applied to a very small bearing area, which results in extremely high operating stresses. During installation, the high stresses developed in the locking collar 14 cause deformation of the locking collar 14 eventually forming into a lock groove 46 on the stem 12a, as shown in FIG. 3, which provides acceptable push out loads. Upon further pulling on the stein 12a by the riveter, the stem 12a breaks as shown in FIG. 3 (at the notch 48 shown in FIGS. 2 and 3), completing the installation of the blind rivet 10.

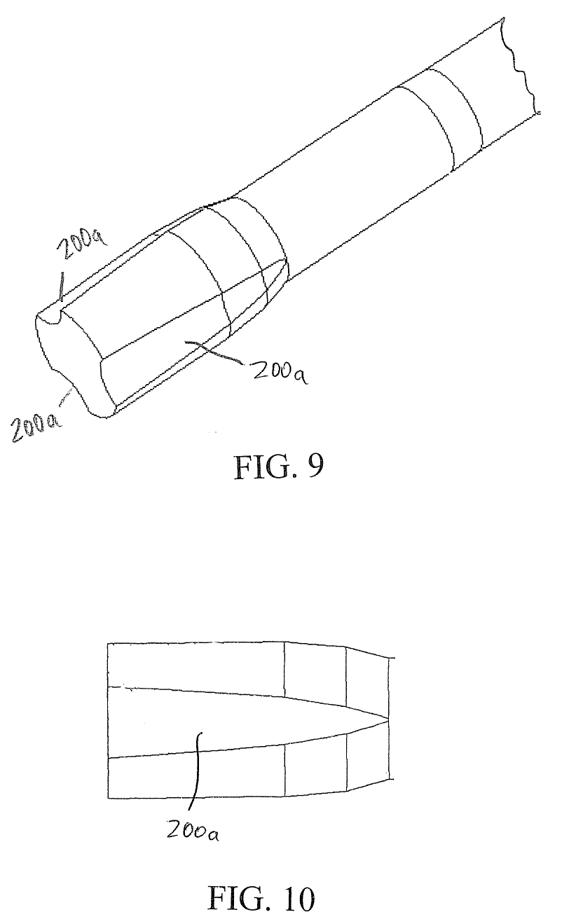

As discussed, the grooves or depressions on the head or plug portion of the stem can vary in number and can take on any number of shapes and sizes while still staying well within the scope of the present invention. While FIGS. 4 and 5 illustrate an embodiment where the grooves or depressions 200 get deeper toward the end of the head 18a of the stem 12a, FIGS. 9 and 10 illustrate a plug design which is in accordance with an alternative embodiment of the present invention. Specifically, in the embodiment illustrated in FIGS. 9 and 10, the grooves or depressions 200a not only get deeper toward the end of the stein, but also get wider.

Regardless of how shaped, etc., preferably the grooves or depressions which are provided on the head portion of the stein provide that lower installation forces can be used to install the blind rivet, and if a sealant or paint is used, provides a type of escape mechanism for the sealant or paint to travel to during installation of the blind rivet. During a “wet” installation, wherein a paint or sealant is applied to the assembly before insertion into the workpiece, the paint or sealant (being highly viscous) may become trapped between the stem and sleeve of a conventional blind rivet. The hydraulic locking effect causes the loads to increase and the stein to break prematurely. Providing grooves or depressions on the plug or head portion of the stem provides a path for the fluid to escape and negate any influence of the added sealants or paint.

Preferably, the grooves or depressions are configured such that they: do not decrease the final upset diameter of the backside of the workpiece; do not adversely affect sheer and tension values of the final assembly; and are fabricated as a part of existing manufacturing processing, thereby creating added value and performance with no added cost.

Additional subtleties of the present invention include added volume to carry more lubrication which is critical for the extrusion process. Though the additional lubrication aids in wiredrawing, it does not impede the escape of any fluid that may be present between the stem and the sleeve.

The present invention allows for the design of a robust fastener that can work with a higher degree of certainty in the structure (with or without sealant). Additionally, the invention allows for the design and manufacturing of smaller-sized fasteners where previous designs have been inadequate in terms of performance.

While specific embodiments of the present invention are shown and described, it is envisioned that those skilled in the art may devise various modifications of the present invention without departing from the spirit and scope of the disclosure.

What is claimed is:

1. A blind rivet comprising: a stem having a serrated portion for gripping and pulling and having a head portion; a locking collar on the stem; a sleeve through which the stem extends, wherein the head portion of the stein comprises at least one groove, wherein the blind rivet is configured such the blind rivet is installable such that the locking collar sets relative to the stem, the head portion of the stein deforms the collar, and the stein breaks.

2. A blind rivet as recited in claim 1, wherein the head portion of the stem comprises a plurality of grooves.

3. A blind rivet as recited in claim 2, wherein the grooves are longitudinal and extend toward an end of the stein.

4. A blind rivet as recited in claim 3, wherein the grooves get deeper toward the end of the stein.

5. A blind rivet as recited in claim 3, wherein the grooves get wider toward the end of the stein.

6. A blind rivet as recited in claim 1, wherein the stem includes an enlarged portion which retains the locking collar and sleeve on the stem.

7. A blind rivet as recited in claim 6, wherein the enlarged portion comprises a knurl.

8. A blind rivet as recited in claim 1, wherein the stem includes a notch at which the stem breaks during installation.

9. A blind rivet as recited in claim 1, wherein the stem includes a lock groove with which the locking collar engages when the locking collar sets during installation of the blind rivet.

10. A blind rivet comprising: a stem having a serrated portion for gripping and pulling and having a head portion; a locking collar on the stem; a sleeve through which the stem extends, wherein the head portion of the stem comprises a plurality of grooves which extend toward an end of the stem, wherein the blind rivet is configured such the blind rivet is installable such that the locking collar sets relative to the stem, the head portion of the stern deforms the collar, and the stem breaks.

11. A blind rivet as recited in claim 10, wherein the grooves get deeper toward the end of the stem.

12. A blind rivet as recited in claim 10, wherein the grooves get wider toward the end of the stem.

13. A blind rivet as recited in claim 10, wherein the stem includes an enlarged portion which retains the locking collar and sleeve on the stem.

14. A blind rivet as recited in claim 13, wherein the enlarged portion comprises a knurl.

15. A blind rivet as recited in claim 10, wherein the stem includes a notch at which the stem breaks during installation.

16. A blind rivet as recited in claim 10, wherein the stein includes a lock groove with which the locking collar engages when the locking collar sets during installation of the blind rivet.
